(19) United States
(12) Patent Application Publication
(10) Pub. No.: US 2011/0299893 A1
(43) Pub. Date: Dec. 8, 2011

(54) DEVELOPING DEVICE AND DEVELOPING METHOD

(75) Inventors: Takayuki TAKAI, Anjo-shi (JP); Takuya Okada, Toyokawa-shi (JP); Takuya Sasaki, Toyokawa-shi (JP); Hokuto Hatano, Toyokawa-shi (JP)

(73) Assignee: Konica Minolta Business Technologies, Inc., Tokyo (JP)

(21) Appl. No.: 13/150,919

(22) Filed: Jun. 1, 2011

(30) Foreign Application Priority Data
Jun. 8, 2010 (JP) 2010-130907

(51) Int. Cl. G03G 15/08; G03G 13/08

(52) U.S. Cl. 399/285

(57) ABSTRACT

A developing device having a plurality of toner carrying members for carrying toner on their outer peripheral surfaces, the plurality of toner carrying members being placed along a rotating direction of an image carrying member and out of contact with the image carrying member; and a developer carrying member for carrying a developer composed of toner and carriers and for supplying the toner to the plurality of toner carrying members. In the developing device, AC bias voltages are applied to the toner carrying members so as to cause the toner carried by the toner carrying members to stick to an electrostatic latent image formed on the image carrying member by the effect of electric fields induced by a voltage of the electrostatic latent image and the AC bias voltages applied to the toner carrying members. The amount of developing toner sticking on the image carrying member immediately after the image carrying member has passed a development area in an upstream side in the rotating direction of the image carrying member is larger than the amount of developing toner sticking on the image carrying member immediately after the image carrying member has passed a development area in a downstream side in the rotating direction of the image carrying member.

This application is based on Japanese Patent Application No. 2010-130907 filed on Jun. 8, 2010, the content of which is herein incorporated by reference.

### BACKGROUND OF THE INVENTION

1. Field of the Invention

The present invention relates to a developing device and a developing method, and more particularly relates to a developing device and a developing method for developing an electrostatic latent image formed on a photosensitive member in an electrophotographic process.

2. Description of Related Art

In recent years, in the field of image formation by electrophotography, attention has been focused on a hybrid developing method having advantages of both a single-component developing method using only toner and a two-component developing method using stirred/mixed toner and carriers as a method for developing an electrostatic latent image formed on a photosensitive member (image carrying member). According to such a hybrid developing method, the following processes are carried out: toner and carriers are stirred and mixed with each other; the toner is electrically charged; thereafter, the toner is separated from the carriers by the effect of a separation electric field formed between a developer carrying roller for carrying a developer (the mixture of toner and carriers) and a developing (toner carrying) roller for supplying the toner to a photosensitive member, so that only the toner is carried by the developing roller. Thus, single-component development is performed for the electrostatic latent image on the photosensitive member.

In such a hybrid developing method, in order to achieve high-speed development, plural developing rollers are placed along the direction of rotations of a photosensitive member to increase a development area (refer to Japanese Patent Laid-Open Publication Nos. 2005-37523 and 2006-276853).

In general, such a hybrid developing device having plural developing rollers are adapted to perform development by forming AC electric fields in the development areas between the photosensitive member and the respective developing rollers and by causing toner to reciprocate between the developing rollers and the photosensitive member. In order to perform development that permits uniformity of each level of finely-tuned densities (amounts of developing toner), it is necessary to cause the toner to reciprocate a sufficient number of times. However, actually, the time period for development has been cut down in return for speed-up and becomes insufficient. In order to compensate for this, the frequencies of AC bias voltages have been increased. However, this countermeasure involves an edge electric field, thereby degrading the line/dot reproducibility.

Further, at portions having lower development potentials, where a smaller amount of toner shall adhere to the photosensitive member, the toner that has moved to the photosensitive member tends to be recaptured by the developing rollers. Accordingly, the characteristic of the amount of developing toner (the amount of toner adhering to the photosensitive member for development) with respect to the development potential is not linear but is S-shaped showing that the amounts of toner in lower development potential portions are smaller. This naturally induces areas having larger gradients of the amount of developing toner with respect to the development potential where the amount of developing toner has higher sensitivity to electric potential unevenness in an electrostatic latent image. Thus, there is a problem that density unevenness is likely to occur in lower potential portions.

### SUMMARY OF THE INVENTION

Therefore, it is an object of the present invention to provide a hybrid-type developing device and a hybrid developing method that are capable of improving the reproducibility of fine lines and fine dots and also capable of suppressing toner density unevenness and fogging.

According to a first aspect of the present invention, a developing device comprises: a plurality of toner carrying members for carrying toner on their outer peripheral surfaces, the plurality of toner carrying members being placed along a rotating direction of an image carrying member and out of contact with the image carrying member, and a developer carrying member for carrying a developer composed of toner and carriers and for supplying the toner to the plurality of toner carrying members; wherein AC bias voltages are applied to the toner carrying members so as to cause the toner carried by the toner carrying members to stick to an electrostatic latent image formed on the image carrying member by the effect of electric fields induced by a voltage of the electrostatic latent image and the AC bias voltages applied to the toner carrying members; and wherein the amount of developing toner sticking on the image carrying member immediately after the image carrying member has passed a development area in an upstream side in the rotating direction of the image carrying member is larger than the amount of developing toner sticking on the image carrying member immediately after the image carrying member has passed a development area in a downstream side in the rotating direction of the image carrying member.

According to a second aspect of the present invention, a developing device comprises: a first toner carrying member for carrying toner on its peripheral surface, the first toner carrying member being capable of rotating while keeping out of contact with an image carrying member; a second toner carrying member for carrying toner on its peripheral surface, the second toner carrying member being capable of rotating while keeping out of contact with the image carrying member and being located downstream from the first toner carrying member in the rotating direction of the image carrying member; a developer carrying member for carrying toner composed of toner and carriers on its peripheral surface and for supplying the toner to the first toner carrying member and the second toner carrying member, the developer carrying member being located opposite to the first toner carrying member and the second toner carrying member; a first voltage application unit for applying an AC bias voltage to the first toner carrying member; and a second voltage application unit for applying an AC bias voltage to the second toner carrying member; wherein the AC bias voltage applied to the second toner carrying member has an average absolute value that is smaller than an average absolute value of the AC bias voltage applied to the first toner carrying member.

According to a third aspect of the present invention, A developing method comprising the steps of: carrying a developer that is composed of toner and carriers on a peripheral surface of a developer carrying member; supplying the toner of the developer from the peripheral surface of the developer carrying member to a plurality of toner carrying members that are placed along a rotating direction of an image carrying member and out of contact with the image carrying member, so that the toner carrying members carry the toner on their peripheral surfaces; and applying AC bias voltages to the toner carrying members so as to cause the toner carried by the toner carrying members to stick to an electrostatic latent image formed on the image carrying member by the effect of electric fields induced by a voltage of the electrostatic latent image and the AC bias voltages applied to the respective toner carrying members; wherein the amount of developing toner sticking onto the image carrying member immediately after the image carrying member has passed a development area in an upstream side in the rotating direction of the image carrying member is larger than the amount of developing toner sticking on the image carrying member immediately after the image carrying member has passed a development area in a downstream side in the rotating direction of the image carrying member.

According to a fourth aspect of the present invention, a developing method comprising the steps of: carrying a developer composed of toner and carriers on a peripheral surface of a developer carrying member located opposite to a first toner carrying member and a second toner carrying member; supplying the toner from the peripheral surface of the developer carrying member to the first toner carrying member and to the second toner carrying member that are capable of rotating while keeping out of contact with an image carrying member, the second toner carrying member being located downstream from the first toner carrying member in the rotating direction of the image carrying member, so that the first toner carrying member and the second toner carrying member carry the toner on their peripheral surfaces; applying an AC bias voltage to the first toner carrying member; and applying an AC bias voltage to the second toner carrying member; wherein an average voltage value of the AC bias voltage applied to the second toner carrying member has a smaller absolute value than an average voltage value of the AC bias voltage applied to the first toner carrying member.

### BRIEF DESCRIPTION OF DRAWINGS

This and other objects and features of the present invention will be apparent from the following description with reference to the accompanying drawings, in which:

FIG. 1 is a cross-sectional view illustrating a developing device according to a first embodiment, a photosensitive drum and peripheral devices thereof;

FIGS. 2A and 2B are chart diagrams illustrating bias voltages applied to developing rollers, wherein FIG. 2A illustrates the relationship between the AC bias voltage applied to the upstream developing roller and the electric potential on a solid latent image formed on the photosensitive member, and FIG. 2B illustrates the relationship between the AC bias voltage applied to the downstream developing roller and the electric potential on a solid latent image formed on the photosensitive member;

FIG. 3 is a chart diagram illustrating the relationship between the average voltage values of the AC bias voltages applied to the developing rollers and the DC bias voltage applied to a developer carrying roller;

FIG. 4 is an illustration showing a state where toner has adhered to the photosensitive member; and

FIG. 5 is a cross-sectional view illustrating a developing device according to a second embodiment, a photosensitive drum and peripheral devices thereof.

### DETAILED DESCRIPTION OF THE PREFERRED EMBODIMENT

There will be hereinafter described developing devices according to the preferred embodiments of the present invention, with reference to the accompanying drawings. In the drawings, common members and parts are designated by common reference characters, and redundant description will be omitted.

### First Embodiment

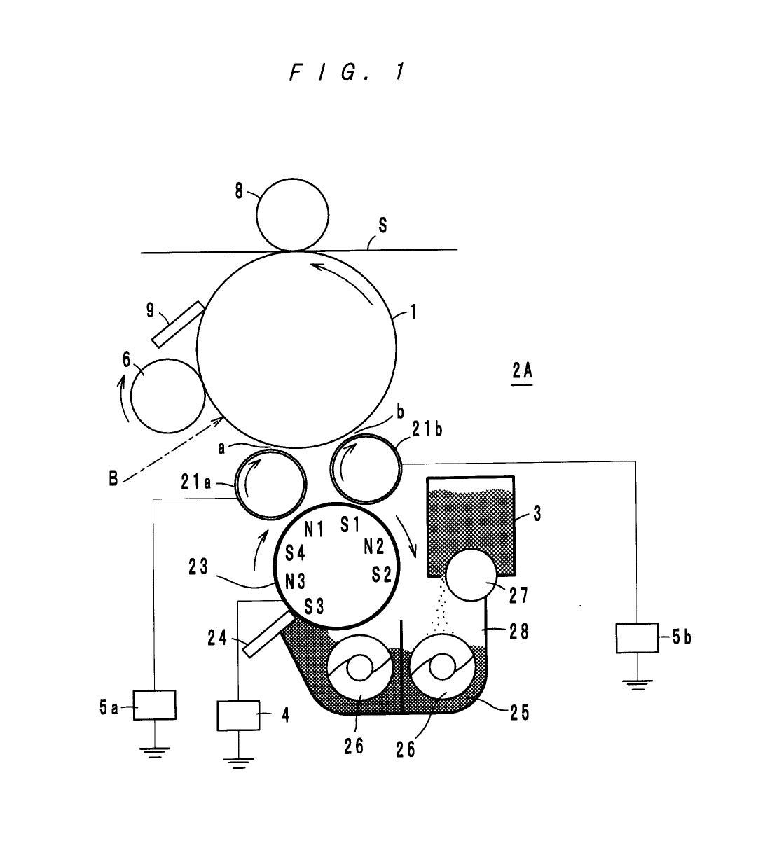

### See FIGS. 1 to 4

A developing device 2A according to a first embodiment is to develop an electrostatic latent image formed on a photosensitive member (image carrying member) 1 into a visible image with toner. The photosensitive member 1 is uniformly charged with a predetermined electric potential by a charging roller 6 as it rotates in the counterclockwise direction indicated by an arrow as illustrated in FIG. 1. An electrostatic latent image is formed on the photosensitive member 1 with a laser beam B emitted from a laser scanning device (not shown). The electrostatic latent image is developed into a toner image by the developing device 2A, and the toner image is transferred to a recording paper sheet S by the effect of an electric field applied thereto from a transferring roller 8. Thereafter, residual toner is removed therefrom by a blade 9, and residual electric charge is removed therefrom by an eraser (not shown). The electrophotographic process by use of such a type of image forming unit is well known, and a description thereof is omitted here.

Further, as the charging unit and the transferring unit, corotron-type or scorotron-type dischargers may be used instead of the roller 6 and the roller 8, and the light exposure device may be one which utilizes light other than laser light.

The developing device 2A carries out hybrid development. The developing device 2A includes a toner supply bottle 3, a developer bath 28 that contains a developer 25 composed of toner and carriers, a developer carrying roller 23 that carries the developer 25 on its outer peripheral surface to transmit the developer 25 in the direction of its rotation (the clockwise direction), and first and second developing (toner carrying) rollers 21a and 21b that separate the toner from the outer peripheral surface of the developer carrying roller 23 and carries the separated toner on their outer peripheral surfaces to transmit the toner in the direction of their rotations (the clockwise direction). Further, a high-voltage power supply circuit 4 is connected to the developer carrying roller 23, while high-voltage power supply circuits 5a and 5b are connected to the first and the second developing rollers 21a and 21b, respectively.

The toner is supplied from the toner supply bottle 3 to the developer bath 28 intermittently, by a predetermined amount at one step, by rotation of a toner supply roller 27. Two stirring/transmitting rollers 26 are placed on the bottom portion of the developer bath 28. The supplied toner is stirred and mixed with the carriers by rotations of the rollers 26, and the toner is electrically charged with a predetermined electric potential and is transmitted to the developer carrying roller 23. The stirring/mixing of the developer 25 with the stirring/transmitting rollers 26 brings the same effects as in conventional developing devices, and the effects will not be described herein.

The developer carrying roller 23 is constituted by a sleeve that is driven to rotate in the direction indicated by arrows (the clockwise direction), and a magnet roller that is incorporated and secured to the sleeve. The magnet roller has magnetic poles N1, S1, N2, S2, S3, N3 and S4, in the rotating direction of the sleeve. The rotating direction of the sleeve is the same as the rotating direction of the first and second developing rollers 21a and 21b, so that the sleeve and the first and second developing rollers 21a and 21b move in the opposite directions at the portions opposing to each other.

The developer 25 that has been transmitted to the vicinity of the developer carrying roller 23 by the stirring/transmitting rollers 26 is carried on the outer peripheral surface of the sleeve by the magnetic force of the magnetic pole S3 in the magnetic roller. The layer thickness of the developer 25 on the sleeve is regulated by a regulation blade 24, and the developer 25 is transmitted to the portions facing to the first and second developing rollers 21a and 21b. The first developing roller 21a is placed in the upstream side in the rotating direction of the photosensitive member 1 (the counterclockwise direction) and is driven to rotate in the clockwise direction as indicated by an arrow. The second developing roller 21b is placed in the downstream side in the rotating direction of the photosensitive member 1 and is driven to rotate in the clockwise direction as indicated by an arrow.

The main magnetic poles N1 and S1 in the magnet roller are placed such that they face to the first and second developing rollers 21a and 21b, respectively, and work to extract the toner from the developer 25 and to supply the toner to the developing rollers 21a and 21b. The magnetic poles S2 and S3 are placed just above the developer bath 28 and generate a repulsive magnetic field for separating the developer 25 from the sleeve.

In the areas where the developer carrying roller 23 face to the first and second developing rollers 21a and 21b, the high-voltage power supply circuit 4 creates electric fields for extracting toner from the developer 25 and moving the toner to the outer peripheral surfaces of the rollers 21a and 21b. Further, in development areas a and b where the first and second developing rollers 21a and 21b face to the photosensitive member 1, the high-voltage power supply circuits 5a and 5b create electric fields for moving the toner from the developing rollers 21a and 21b to the outer peripheral surface of the photosensitive member 1.

The toner that was supplied from the developer carrying roller 23 and that has been carried in a layer shape by the outer peripheral surface of the first developing roller 21a is then transmitted to the development area a facing to the photosensitive member 1 by the rotation of the first developing roller 21a. Due to the electric field induced by the voltage of the electrostatic latent image formed on the photosensitive member 1 and the AC bias voltage applied to the developing roller 21a from the high-voltage power supply circuit 5a, the toner is caused to reciprocate between the photosensitive member 1 and the developing roller 21a, thereby developing the electrostatic latent image. Also, the toner that was supplied from the developer carrying roller 23 and that has been carried in a layer shape by the outer peripheral surface of the second developing roller 21b is then transmitted to the development area b facing to the photosensitive member 1 by the rotation of the second developing roller 21b. Due to the electric field induced by the voltage of the electrostatic latent image formed on the photosensitive member 1 and the AC bias voltage applied to the developing roller 21b from the high-voltage power supply circuit 5b, the toner is caused to reciprocate between the photosensitive member 1 and the developing roller 21b, thereby developing the electrostatic latent image.

The developing rollers 21a and 21b are electrically-conductive rollers made of a metal material, for example, aluminum rollers having surfaces that have been subjected to an alumite treatment. The bodies of the rollers may be coated with polyester resin, polycarbonate resin, polyethylene resin, polyamide resin, polyimide resin, polysulfone resin, silicone resin, fluorocarbon resin or the like, or may be coated with silicone rubber or urethane rubber or the like.

The toner used in the developer may be of an ordinary type that contains binder resin as the main component and that, if needed, contains a coloring agent, a charge control agent, a mold release material and the like with other agents externally added. The toner desirably has particle sizes of about 3 to 10 micrometers. The carrier used in the developer may be of a binder type or a coat type, which are generally used. The carriers preferably have particle sizes of about 15 to 100 micrometers. The mixing ratio between the toner and the carriers is required only to be adjusted such that a desired charge amount of the toner can be attained and, in actual, the mixing ratio is set such that about 20 to 40% of the surface of each carrier will be coated with toner.

Hereinafter, there will be described the bias voltages applied to the developing rollers 21a and 21b. The high-voltage power supply circuits 4, 5a and 5b create AC electric fields between the developing roller 21a and the developer carrying roller 23 and between the developing roller 21b and the developer carrying roller 23, and the AC electric fields provide, therebetween, an electric-potential relationship that permits toner supply from the developer carrying roller 23 to the developing rollers 21a and 21b. The developing rollers 21a and 21b are placed out of contact with the photosensitive member 1, and in the development areas a and b, which are spaces between the developing roller 21a and the photosensitive member 1 and between the developing roller 21b and the photosensitive member 1, AC electric fields are created so as to cause the toner to fly through the spaces by the effect of the electric fields for accurate development of the electrostatic latent image on the photosensitive member 1.

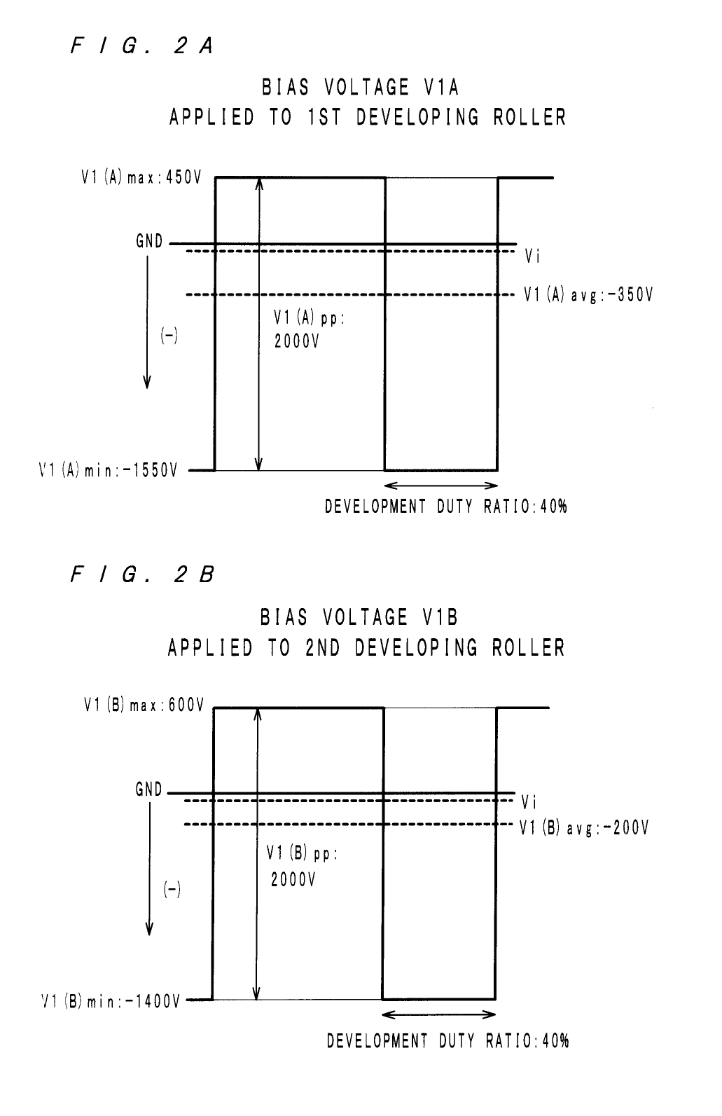

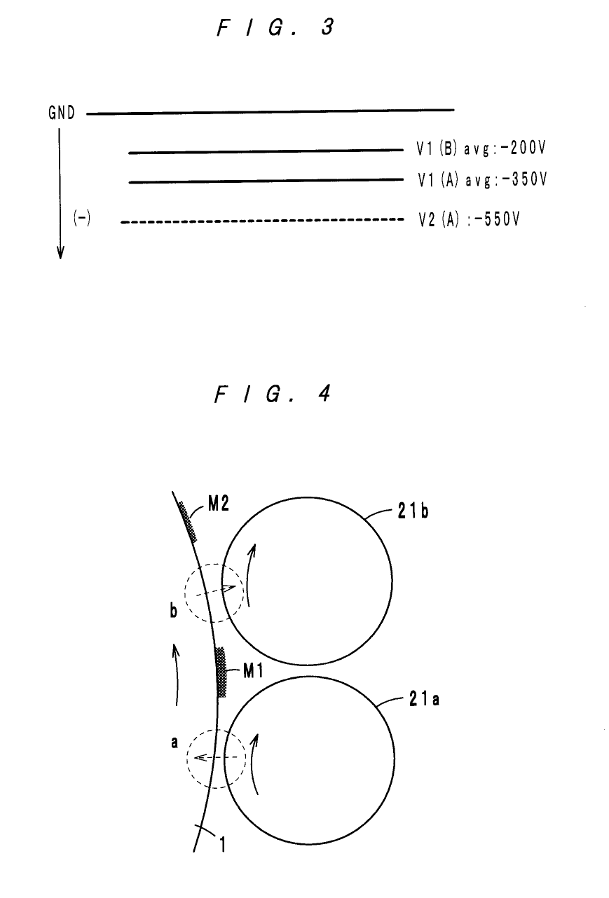

FIG. 2A illustrates the relationship between the AC bias voltage applied to the first developing roller 21a located in the upstream side and the electric potential on the solid latent image on the photosensitive member 1, and FIG. 2B illustrates the relationship between the AC bias voltage applied to the second developing roller 21b located in the downstream side and the electric potential on the solid latent image on the photosensitive member 1. FIG. 3 illustrates the relationship among the average voltage values of the AC bias voltages applied to the developing rollers 21a and 21b and the voltage value of the DC bias voltage applied to the developer carrying roller 23. The photosensitive member 1 and the toner are negatively charged. The voltage values in FIG. 2 and FIG. 3 will be described specifically with reference to the experiments that will be described below.

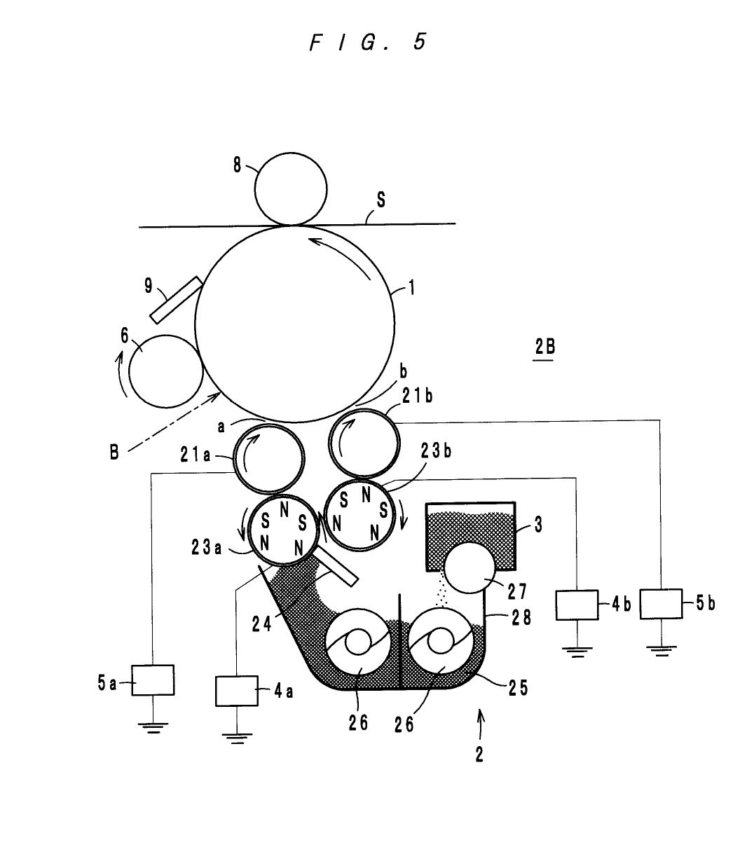

In the developing device 2A, as illustrated in FIG. 4, the AC bias voltages applied from the high-voltage power supply circuits 5a and 5b are such values that the amount M1 of developing toner (toner sticking on the latent image on the photosensitive member 1) immediately after the photosensitive member 1 has passed the developing area a facing to the first (upstream) developing roller 21a is larger than the amount M2 of developing toner immediately after the photosensitive member 1 has passed the developing area b facing to the second (downstream) developing roller 21b.

Specifically, as illustrated in FIGS. 2A and 2B, square-wave AC bias voltages are applied to the developing rollers 21a and 21b, and the toner is transferred to the photosensitive member 1 by amounts corresponding to the potential difference between the electric potential Vi on the solid image portion of the electrostatic latent image and the average voltage value V1(A) avg(−350 V) of the AC bias voltage applied to the roller 21a and the potential difference between the electric potential Vi on the solid image portion of the electrostatic latent image and the average value V1(B) avg(−200V) of the AC bias voltage applied to the roller 21b. The toner moves to the photosensitive member 1 when the applied bias voltages are the minimum values, while the toner moves to the developing rollers 21a and 21b when the voltages are the maximum values. The ratio of the minimum-value period to the full period refers to a development duty ratio, and in the present embodiment, the development duty ratio is set to 40%.

In the present embodiment, the average potential difference in the development area a between the photosensitive member 1 and the upstream developing roller 21a is larger than the average potential difference in the development area b between the photosensitive member 1 and the downstream developing roller 21b. In other words, the average voltage value of the AV bias voltage applied to the upstream developing roller 21a has a larger absolute value than the average voltage value of the AC bias voltage applied to the downstream developing roller 21b. Therefore, as illustrated in FIG. 4, the amount M1 of developing toner immediately after the photosensitive member 1 has passed the development area a is larger than the amount M2 of developing toner immediately after the photosensitive member 1 has passed the development area b.

Conventional developing devices are adapted to attain target amounts of developing toner by accumulating the amounts of developing toner achieved in the development areas a and b. On the contrary, in the developing device 2A according to the present embodiment, the amount M1 of developing toner immediately after the photosensitive member 1 has passed the upstream developing area a is excessively large, that is, excessive development is performed in the upstream developing area a, and thereafter, the amount M2 of developing toner immediately after the photosensitive member 1 has passed the downstream developing area b becomes smaller, that is, the excess toner is recaptured from the photosensitive member 1 in the downstream developing area b. This results in improvement of the reproducibility of fine lines and fine dots and suppression of toner density unevenness and fogging particularly in low density portions.

### Other Methods of Adjusting the Amount of Developing Toner

Further, the amounts M1 and M2 of developing toner in the development areas a and b can be adjusted by changing the development duty ratio or by changing the waveforms of the AC bias voltages, as well as by changing the average values of the AC bias voltages as described above. For example, the bias voltage applied to the first developing roller 21a may be a sawtooth-wave voltage that permits an abrupt voltage change to move the toner to the photosensitive member 1, while the bias voltage applied to the second developing roller 21b may be a sawtooth-wave voltage that permits an abrupt voltage change to move the toner back from the photosensitive member 1. Alternatively, these bias voltages may be square-wave voltages having periods of 0V among the square waves as illustrated in FIGS. 2A and 2B.

### Second Embodiment

### See FIG. 5

In a developing device 2B according to a second embodiment, as illustrated in FIG. 5, the developer carrying roller 23 as described in connection with the first embodiment is adapted to be composed of a first developer carrying roller 23a facing to the first developing roller 21a and a second developer carrying roller 23b facing to the second developing roller 21b. The first developer carrying roller 23a rotates in the counterclockwise direction, while the second developer carrying roller 23b rotates in the clockwise direction. All the other components are the same as those in the first embodiment illustrated in FIG. 1.

The developer 25 is first supplied from the developer bath 28 to the first developer carrying roller 23a with the layer thickness on the developer carrying roller 23a regulated by the regulation blade 24. In the portion where the rollers 23a and 23b face to each other, due to the effect of magnets incorporated in the rollers 23a and 23b, a half amount of the toner carried by the first developer carrying roller 23a is supplied to the second developer carrying roller 23b. Thereafter, the toner is supplied from the rollers 23a and 23b to the developing rollers 21a and 21b, respectively. Development is performed by the developing rollers 21a and 21b in the same manner as described in connection with the first embodiment while AC development bias voltages as shown by FIGS. 2A and 2B. Accordingly, like in the first embodiment, with the developing device 2B according to the second embodiment, the reproducibility of fine lines and fine dots can be improved, and toner density unevenness and fogging particularly in low density portions can be suppressed.

### Experiments

Experiments were conducted as follows, using the developing device 2A according to the first embodiment. The system speed (the sheet feeding speed) was 700 mm/sec. As illustrated in FIGS. 2A, 2B and 3, a DC voltage of 550 V was applied to the developer carrying roller 23. A square-wave AC bias voltage with an amplitude of 2 kV, a minimum value Vmin of −1550 V, a maximum value Vmax of 450 V, an average value Vavg of −350 V, a development duty ratio of 40% and a frequency of 5 kHz was applied to the first developing roller 21a. A square-wave AC bias voltage with an amplitude of 2 kV, a minimum value Vmin of −1400 V, a maximum value Vmax of 600 V, an average value Vavg of −200 V, a development duty ratio of 40% and a frequency of 5 kHz was applied to the second developing roller 21b.

Between the developing roller 21a and the developer carrying roller 23, an effective potential difference ΔVavg of 200 V is caused, and between the developing roller 21b and the developer carrying roller 23, an effective potential difference ΔVavg of 350 V is caused. Thereby, electric fields that permit toner supply are generated. The gaps between the developer carrying roller 23 and the developing roller 21a and between the developer carrying roller 23 and the developing roller 21b were set to 0.5 mm at the respective closest portions. The gap between the regulation blade 24 and the developer carrying roller 23 was set such that the amount of developer carried on the developer carrying roller 23 per unit area became a target amount.

The electric potential on the background portion of an electrostatic latent image formed on the photosensitive member 1 was −450 V, and that on the solid image portion of the electric latent image was −50 V. The gaps between the photosensitive member 1 and the developing roller 21a and between the photosensitive member 1 and the developing roller 21b were set to 0.2 mm at the respective closest portions. Further, the rotational speed of the developing rollers 21a and 21b was set such that the ratio of the rotational peripheral speed of the rollers 21a and 21b to the rotational peripheral speed of the photosensitive member 1 was 1.5:1.

As the developer, the following one was used. The toner used therein had a negative polarity. The base material of the toner was prepared by a wet granulation process to have particles of an average size of 6.5 micrometers, and to 100 part weight of the base material, 0.2 part weight of first kind of hydrophobic silica, 0.5 part weight of a second kind of hydrophobic silica and 0.5 part weight of hydrophobic titanium oxide were added. The carriers were coat-type carriers having magnetic core particles coated with acrylic-based resin, and the carriers had an average particle size of about 33 micrometers. The percentage of the toner in the developer (the percentage of the weight of the toner to the total weight of the developer) was 8 wt %.

Under the conditions above, printing processes were performed while varying the average voltage values Vavg of the bias voltages applied to the developing rollers 21a and 21b as indicated in inventive examples 1 to 4 and comparative examples 1 to 5 in the following Table 1. During the processes, the potential differences for toner supply between the developing roller 21a and the developer carrying roller 23 and between the developing roller 21b and the developer carrying roller 23 were maintained constant. Table 1 indicates the correlation between image quality and the amounts M1 and M2 of developing toner that adhered to a solid image portion after the portion has passed the development areas a and b. The amount of developing toner on the solid image portion after the solid image portion has passed the downstream development area b was set to 5 g/m², which can realize a necessary image density.

The image quality was evaluated in terms of reproducibility of 1-dot fine lines at 1200 dpi, density unevenness in half-tone portions and fogging. Based on the results of evaluation, the printed images were classified into different quality levels, namely, in an excellent level indicated with double circles, a practically good level indicated with circles and in an undesirable level indicated with crosses. All the inventive examples 1 to 4 satisfied the relationship M1>M2 and were given preferable results in all the image quality evaluation items.

On the contrary, all the comparative examples 1 to 5 induced the relationship M1≦M2 and were given undesirable results in at least one of the evaluation items of fine-line reproducibility, density unevenness and fogging. Further, the comparative examples 2 and 3, wherein the amount M2 of developing toner was set to more than 5 g/m², the toner consumption is increased, thereby increasing the running cost, and the reproducibility of fine outlines of blank portions in a solid image is lowered.

TABLE 1

| | Conditions | | | | Evaluation Items | | |
|---|---|---|---|---|---|---|---|
| | V1(A)avg | V1(B)avg | M1 | M2 | Reproducibility | Density | |
| | (V) | (V) | (g/m²) | (g/m²) | of Fine Lines | Unevenness | Fogging |
| Inventive | −350 | −200 | 7 | 5 | ⊚ | ⊚ | ⊚ |
| Example 1 | | | | | | | |
| Inventive | −275 | −200 | 6 | 5 | ⊚ | ⊚ | ⊚ |
| Example 2 | | | | | | | |
| Inventive | −238 | −200 | 5.5 | 5 | ◯ | ⊚ | ⊚ |
| Example 3 | | | | | | | |
| Inventive | −425 | −200 | 8 | 5 | ⊚ | ⊚ | ◯ |
| Example 4 | | | | | | | |
| Comparative | −200 | −200 | 5 | 5 | X | X | ⊚ |
| Example 1 | | | | | | | |
| Comparative | −200 | −275 | 5 | 6 | ◯ | X | X |
| Example 2 | | | | | | | |
| Comparative | −200 | −350 | 5 | 7 | ⊚ | X | X |
| Example 3 | | | | | | | |
| Comparative | −50 | −200 | 3 | 5 | X | X | ⊚ |
| Example 4 | | | | | | | |
| Comparative | −125 | −200 | 4 | 5 | X | X | ⊚ |
| Example 5 | | | | | | | |

### Other Embodiments

The rotating directions of the photosensitive member, the developer carrying roller and the first and second developing rollers are not limited to those described in the embodiments above. The rollers in the developing device can be made of various materials. Further, for the developer, toner and carriers of various materials can be used. Also, either known normal development or known reversal development may be adopted.

As described above, in the developing devices according to the embodiments of the present invention, the amount of developing toner sticking to the photosensitive member immediately after the photosensitive member has passed the upstream development area is larger than the amount of developing toner sticking to the photosensitive member immediately after the photosensitive member has passed the downstream development area, that is, the excessive toner that adhered to the photosensitive member in the upstream development area is recaptured in the downstream development area. Consequently, the reproducibility of fine lines and fine dots can be improved, and toner density unevenness and fogging can be suppressed.

Although the present invention has been described in connection with the preferred embodiments above, it is to be noted that various changes and modifications are possible to those who are skilled in the art. Such changes and modifications are to be understood as being within the scope of the present invention.

What is claimed is:

1. A developing device comprising:
a plurality of toner carrying members for carrying toner on their outer peripheral surfaces, the plurality of toner carrying members being placed along a rotating direction of an image carrying member and out of contact with the image carrying member; and
a developer carrying member for carrying a developer composed of toner and carriers and for supplying the toner to the plurality of toner carrying members;
wherein AC bias voltages are applied to the toner carrying members so as to cause the toner carried by the toner carrying members to stick to an electrostatic latent image formed on the image carrying member by the effect of electric fields induced by a voltage of the electrostatic latent image and the AC bias voltages applied to the toner carrying members; and
wherein the amount of developing toner sticking on the image carrying member immediately after the image carrying member has passed a development area in an upstream side in the rotating direction of the image carrying member is larger than the amount of developing toner sticking on the image carrying member immediately after the image carrying member has passed a development area in a downstream side in the rotating direction of the image carrying member.

2. A developing device according to claim 1, wherein an average voltage value of the AC bias voltage applied to a toner carrying member in an upstream side in the rotating direction of the image carrying member has a larger absolute value than that of the AC bias voltage applied to a toner carrying member in a downstream side in the rotating direction of the image carrying member.

3. A developing device comprising:
a first toner carrying member for carrying toner on its peripheral surface, the first toner carrying member being capable of rotating while keeping out of contact with an image carrying member;
a second toner carrying member for carrying toner on its peripheral surface, the second toner carrying member being capable of rotating while keeping out of contact with the image carrying member and being located downstream from the first toner carrying member in the rotating direction of the image carrying member;
a developer carrying member for carrying toner composed of toner and carriers on its peripheral surface and for supplying the toner to the first toner carrying member and the second toner carrying member, the developer carrying member being located opposite to the first toner carrying member and the second toner carrying member;
a first voltage application unit for applying an AC bias voltage to the first toner carrying member; and
a second voltage application unit for applying an AC bias voltage to the second toner carrying member;
wherein the AC bias voltage applied to the second toner carrying member has an average absolute value that is smaller than an average absolute value of the AC bias voltage applied to the first toner carrying member.

4. A developing device according to claim 3,
wherein the AC bias voltages applied to the first toner carrying member and the second toner carrying member are superimposed voltages that are each composed of an AC component and a DC component; and
wherein the AC component of the superimposed voltage applied to the first toner carrying member and the AC component of the superimposed voltage applied to the second toner carrying member are of an identical waveform, and the DC component of the superimposed voltage applied to the first toner carrying member and the DC component of the superimposed voltage applied to the second toner carrying member have mutually different voltage values.

5. A developing device according to claim 4, wherein the AC component of the superimposed voltage applied to the first toner carrying member and the AC component of the superimposed voltage applied to the second toner carrying member have a same voltage value.

6. A developing device according to claim 3, wherein the AC bias voltage applied to the first toner carrying member and the AC bias voltage applied to the second toner carrying member have mutually different duty ratios.

7. A developing device according to claim 3, wherein the AC bias voltage applied to the first toner carrying member and the AC bias voltage applied to the second toner carrying member are of mutually different waveforms.

8. A developing device according to claim 7, wherein the AC bias voltage applied to the first toner carrying member is of a sawtooth waveform that permits an abrupt voltage change to move the toner to the image carrying member, and the AC bias voltage applied to the second toner carrying member is of a sawtooth waveform that permits an abrupt voltage change to move the toner back from the image carrying member.

9. A developing method comprising the steps of:
carrying a developer that is composed of toner and carriers on a peripheral surface of a developer carrying member;
supplying the toner of the developer from the peripheral surface of the developer carrying member to a plurality of toner carrying members that are placed along a rotating direction of an image carrying member and out of contact with the image carrying member, so that the toner carrying members carry the toner on their peripheral surfaces; and
applying AC bias voltages to the toner carrying members so as to cause the toner carried by the toner carrying members to stick to an electrostatic latent image formed on the image carrying member by the effect of electric fields induced by a voltage of the electrostatic latent image and the AC bias voltages applied to the respective toner carrying members;
wherein the amount of developing toner sticking onto the image carrying member immediately after the image carrying member has passed a development area in an upstream side in the rotating direction of the image carrying member is larger than the amount of developing toner sticking on the image carrying member immediately after the image carrying member has passed a development area in a downstream side in the rotating direction of the image carrying member.

10. A developing method according to claim 9, wherein an average voltage value of the AC bias voltage applied to a toner carrying member in an upstream side in the rotating direction of the image carrying member has a larger absolute value than that of the AC bias voltage applied to a toner carrying member in a downstream side in the rotating direction of the image carrying member.

11. A developing method comprising the steps of
carrying a developer composed of toner and carriers on a peripheral surface of a developer carrying member located opposite to a first toner carrying member and a second toner carrying member;
supplying the toner from the peripheral surface of the developer carrying member to the first toner carrying member and to the second toner carrying member that are capable of rotating while keeping out of contact with an image carrying member, the second toner carrying member being located downstream from the first toner carrying member in the rotating direction of the image carrying member, so that the first toner carrying member and the second toner carrying member carry the toner on their peripheral surfaces;
applying an AC bias voltage to the first toner carrying member; and
applying an AC bias voltage to the second toner carrying member;
wherein an average voltage value of the AC bias voltage applied to the second toner carrying member has a smaller absolute value than an average voltage value of the AC bias voltage applied to the first toner carrying member.

12. A developing method according to claim 11,
wherein the AC bias voltages applied to the first toner carrying member and to the second toner carrying member are superimposed voltages that are each composed of an AC component and a DC component; and
wherein the AC component of the superimposed voltage applied to the first toner carrying member and the AC component of the superimposed voltage applied to the second toner carrying member are of an identical waveform, and the DC component of the superimposed voltage applied to the first toner carrying member and the DC component of the superimposed voltage applied to the second toner carrying member have mutually different voltage values.

13. A developing method according to claim 12, wherein the AC component of the superimposed voltage applied to the first toner carrying member and the AC component of the superimposed voltage applied to the second toner carrying member have a same voltage value.

14. A developing method according to claim 11, wherein the AC bias voltage applied to the first toner carrying member and the AC bias voltage applied to the second toner carrying member have mutually different duty ratios.

15. A developing method according to claim 3, wherein the AC bias voltage applied to the first toner carrying member and the AC bias voltage applied to the second toner carrying member are of mutually different waveforms.

16. A developing method according to claim 15, wherein the AC bias voltage applied to the first toner carrying member is of a sawtooth waveform that permits an abrupt voltage change to move the toner to the image carrying member, and the AC bias voltage applied to the second toner carrying member is of a sawtooth waveform that permits an abrupt voltage change to move the toner back from the image carrying member.
